(19) United States
(12) Patent Application Publication
(10) Pub. No.: US 2021/0052456 A1
(43) Pub. Date: Feb. 25, 2021

(54) SPINAL DECOMPRESSION MACHINE AND METHOD OF PROVIDING THE SAME

(71) Applicant: CONG THANH DIEP TU, HO CHI MINH CITY (VN)

(72) Inventor: CONG THANH DIEP TU, HO CHI MINH CITY (VN)

(73) Assignee: TON DUC THANG UNIVERSITY

(21) Appl. No.: 15/607,445

(22) Filed: May 27, 2017

(51) Int. Cl. A61H 1/02

(52) U.S. Cl. CPC A61H 1/0222; A61H 2201/1238; A61H 2201/1652; A61H 2201/5061; A61H 2201/1604; A61H 2203/0456; A61H 2201/0142; A61H 2201/1635

(57) ABSTRACT

A spinal decompression machine (SDM) and method of use are disclosed which comprises: a base connected to a bed frame, a weight assembly, a pneumatic artificial muscle (PAM) motor, and a first pulley system selectively connected to either or both of weight assembly and the PAM motor for providing a weight mode in which a first decompression force is provided only by said weight assembly, a pneumatic artificial muscle (PAM) in which second decompression force is provided only by the PAM motor, or a combined mode in which a combined decompression force is provided by the PAM motor and the weight assembly.

### FIELD OF THE INVENTION

The present invention relates generally to the field of medical devices. More specifically, the present invention relates to a spinal decompression machine.

### BACKGROUND ART

Back and neck pains are significant health problems in our society. Symptoms are often recurrent, even if the original presentation has been resolved, and many people suffer chronic unremitting symptomatology. Disc degeneration, bulges and herniations are primary causes of neck or low back pain. Surgical intervention, often with fusion, is frequently used, but the end result can be reduced mobility, stiffness and continuing pain. The high incidence of chronicity, recurrence of pain, and failed back syndrome for patients with neck and back pain suggests that treatments other than surgical interventions are needed.

One known method to treat neck and back problems is traction. Traction can be defined as an intermittent or continuous force applied along the long axis of the spine in an attempt to elongate the spine. However, pain relief with traction has been inconsistent and short-lived because when traction is applied the body reacts by pulling in the opposite direction.

Conventional spinal decompression equipment, on the other hand, contains sensitive computer-feedback mechanisms, such as strain gauges, to overcome traction problems and allow for maximum therapeutic results. A strain gauge is designed to convert mechanical motion into an electronic signal. This allows the equipment to continuously monitor muscular reaction and to compensate by re-adjusting its distraction parameters. Each treatment is centered on variety of adjustable logarithmic ramp-up, hold and release protocols implemented by the computerized system designed to bypass the proprioceptive response of ligaments and muscles to distraction. However, the conventional computer-feedback spinal decompression machines are expensive, complex, and difficult to maintain.

It has been shown that tension forces to the spine applied in a ‘logarithmic’ time/force curve will decompress the discs and spine. Vertebral axial decompression is the only treatment that has been shown in clinical study to decrease the intervertebral disc pressure to negative levels and to decompress the lateral nerve roots that supply the legs. While this known vertebral axial decompression therapy is advantageous, an improved vertebral decompression therapy would be desirable.

In some other spinal decompression machines, a carriage is slidable along a portion of a support structure parallel to a longitudinal axis. The carriage includes a restraining mechanism adapted to releasably restrain a portion of a patient's body to the carriage. The pneumatic traction force generating apparatus is a larger diameter cylinder, that when used with low pressure input devices, are more prone to leak, thereby further complicating the problem of maintaining a constant traction force for a prolonged period of time. The cylinder is operatively coupled to move the carriage relative to the support structure when in a pressurized state. The pneumatic traction force generating apparatus is adapted to maintain a generally static traction force during a treatment period when in the pressurized state without additional pressurized air being supplied. A hand pump operated by the patient is fluidly connected to the pneumatic traction force generating apparatus to inject pressurized air. The hand pump is capable of injecting at least 138 kPa (20 psi) of pressure into the pneumatic traction force generating apparatus. It should be noted that the recommended amount of minimum traction decompression pressure should be equal to one half of the patient's body weight. Therefore these existing spinal decompression machines do not supply even the minimum amount of decompression pressure required for adequate treatment. A pressure relief mechanism operated by the patient is adapted to release pressure from the pneumatic traction force generating apparatus. However, these methods are not as good as the horizontal separation employed in the very expensive machines.

Therefore what is needed is an effective, low-cost, easy to maintain, simple to operate spinal decompression machine that can find and update the appropriate decompression force for each patient.

### SUMMARY OF THE INVENTION

The present invention has been made in view of the aforementioned circumstances, and therefore, an object of the present invention is to provide a novel spinal decompression machine (SDM) which makes it possible to achieve appropriate and constant decompression force for a long term therapeutic session.

Another object of the present invention is to provide spinal decompression machine (SDM) that is flexible and easy to use with three different mode of operations: a weight mode, a pneumatic artificial muscle (PAM), and a combined mode.

Yet another objective of the present invention is to provide a novel method of use of the disclosed spinal decompression machine.

The above objectives are achieved by providing a spinal decompression machine (SDM) which comprises: a base connected to a bed frame, a weight assembly, a pneumatic artificial muscle (PAM) motor, and a first pulley system selectively connected to either or both of weight assembly and the PAM motor for providing a weight mode in which a first decompression force is provided only by said weight assembly, a pneumatic artificial muscle (PAM) in which second decompression force is provided only by the PAM motor, or a combined mode in which a combined decompression force is provided by the PAM motor and the weight assembly.

Another objective of the present invention is to provide a method of use of the spinal decompression machine described above which comprises the following steps: determining an appropriate decompression force for each patient; recording the decompression force for each patient; and using a controller to control the pneumatic artificial muscle (PAM) and/or the weight assembly to provide a weight mode in which a first decompression force is provided only by the weight assembly, a pneumatic artificial muscle (PAM) in which second decompression force in provided only by the PAM, or a combined mode in which a combined decompression force is provided by the PAM and the weight assembly.

These and other advantages of the present invention will no doubt become obvious to those of ordinary skill in the art after having read the following detailed description of the preferred embodiments, which are illustrated in the various drawing Figures.

### BRIEF DESCRIPTION OF THE DRAWINGS

The accompanying drawings, which are incorporated in and form a part of this specification, illustrate embodiments of the invention and, together with the description, serve to explain the principles of the invention.

FIG. 1 is a diagram illustrating a side view of a spinal decompression machine (SDM) in accordance with an embodiment of the present invention;

FIG. 2 is a diagram illustrating a top view of the SDM of FIG. 1 without a first pallet and a second pallet in accordance with an embodiment of the present invention;

FIG. 3 is a diagram illustrating a side view of the SDM of FIG. 1 disconnected at the extension and the bottom section of the bed frame and without the first pallet and the second pallet in accordance with an embodiment of the present invention;

FIG. 4 is a diagram illustrating the top down view of the SDM of FIG. 1 without the first pallet and the second pallet in accordance with an embodiment of the present invention;

FIG. 5 is a diagram illustrating a spatial arrangement of a second pulley system and a pneumatic artificial muscle (PAM) in accordance with an embodiment of the present invention;

FIG. 6 is a diagram illustrating a top view of the SDM of FIG. 1 with a patient being secured by a chest belt and a harness in accordance with an embodiment of the present invention;

FIG. 7 is a diagram illustrating side view of the SDM with a patient being secured by a chest belt and a harness in accordance with an embodiment of the present invention;

FIG. 8 is a schematic diagram illustrating a control system of the SDM of FIG. 1 in accordance with an embodiment of the present invention; and

FIG. 9 is a flow chart illustrating the method of use of the SDM in accordance with an embodiment of the present invention.

### DETAILED DESCRIPTION OF THE INVENTION

Reference will now be made in detail to the preferred embodiments of the invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the present invention, numerous specific details are set forth in order to provide a thorough understanding of the present invention. However, it will be obvious to one of ordinary skill in the art that the present invention may be practiced without these specific details. In other instances, well-known methods, procedures, components, and circuits have not been described in detail so as not to unnecessarily obscure aspects of the present invention.

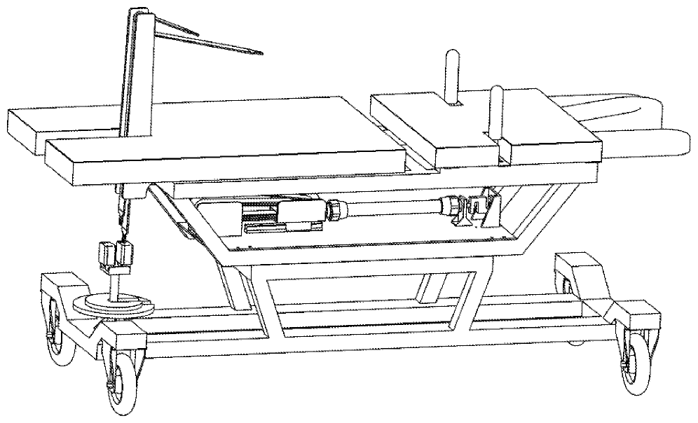

Now referring to FIG. 1, a diagram of a spinal decompression machine (SDM) 100 of an exemplary embodiment of the present invention is illustrated. SDM 100 includes a base 110, a bed frame 130, a weight assembly 120, a first pulley system 140, a pneumatic artificial muscle (PAM) system 170, and a second pulley system 180. In detail, base 110 is mounted on a first caster wheel 101, a second caster wheel 102, a third wheel 103, and a fourth wheel 104. First caster wheel 101, second caster wheel 102, third caster 103, and fourth caster wheel 104 are arranged from front to back at four corners of a bottom side of base 110 respectively. SDM 100 is operative to provide three different modes: a weight mode, a PAM mode, and a combined mode. In the weight mode, SDM 100 provides a first decompression force from weight assembly 120. In the PAM mode, SDM 100 provides a second decompression force from PAM system 170. Finally, in the combined mode, SDM 100 provides a third decompression mode from the combination of weight assembly 120 and PAM system 170. Base 110 also includes an extension 111 extending vertically from base 110. Bed frame 130 includes a top section 130_1 and a bottom section 130_2. Bottom section 130_2 is mounted directly on top of extension 111. It is appreciated by a person of ordinary skills in the art that connections between various components described herewith may be by any suitable means such as nails, screws, bolts, connectors, pins, staples, dowels and the like.

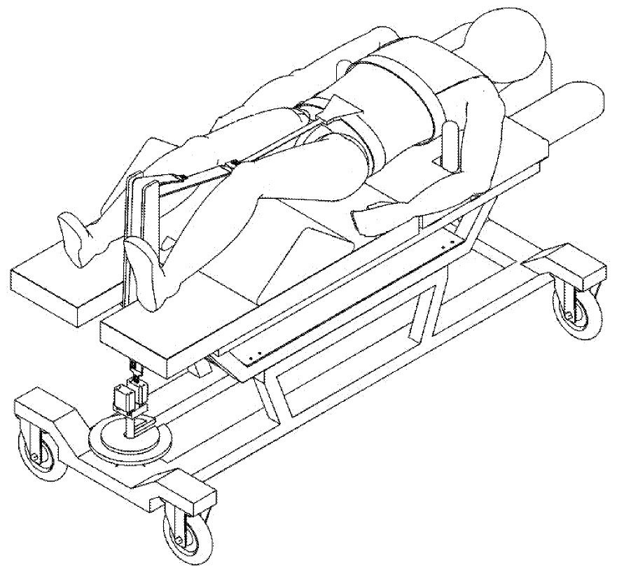

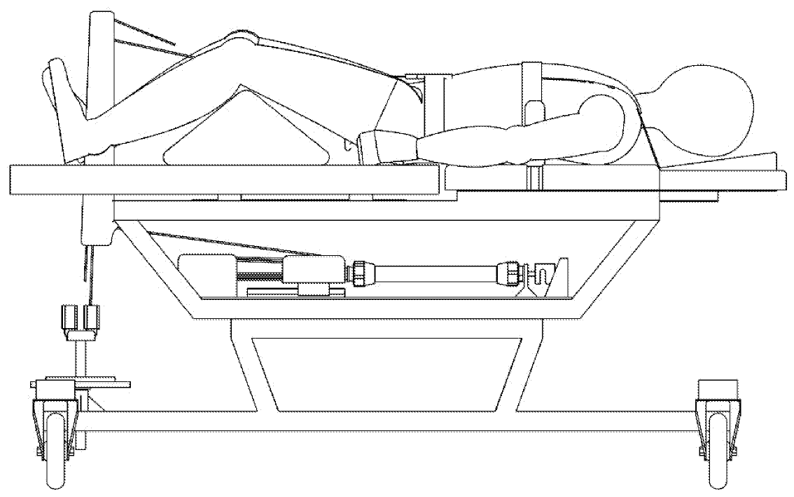

Continuing with the discussion of FIG. 1, weight assembly 120 is positioned at the middle of the bottom end of base 110 near first caster wheel 101 and second caster wheel 102. In an exemplary embodiment, weight assembly 120 includes a circular weight platform 121, a weight pin 122 extended vertically upward from the center of circular weight platform 121, a plural of weight 123 inserted into weight pin 122, a first connector 124, and a second connector 125. Both first connector 124 and second connector 125 are a positioned on top of weight adder pin 122. First pulley system 130_3 includes a first pulley housing 131 connected to the middle of the bottom end of top section 130_1 right above weight assembly 120. First pulley system 130_3 further includes a series of pulleys (not shown) arranged vertically along the length of first pulley housing 131. A first cable 132 connects a patient (not shown in FIG. 1, see FIG. 6 and FIG. 7) directly to weight assembly 120 to provide the first decompression force in the weight mode. A second cable 133 connects the patient to PAM 170 to provide the second decompression force in the PAM mode. A third cable 134 connects the patient to both PAM 170 and weight assembly 120 to provide the third decompression force in the combined mode.

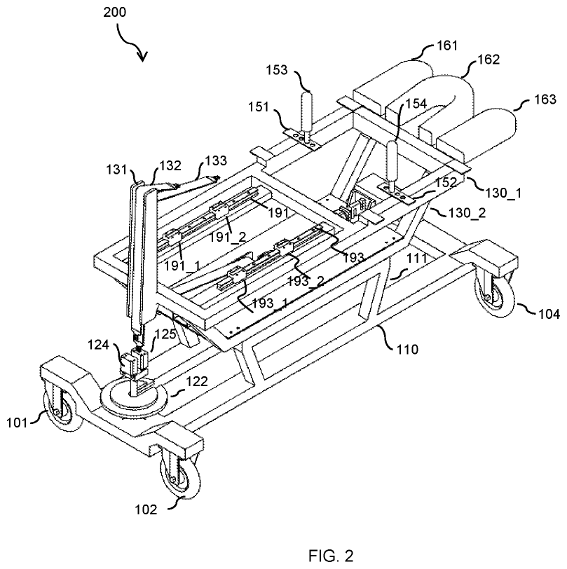

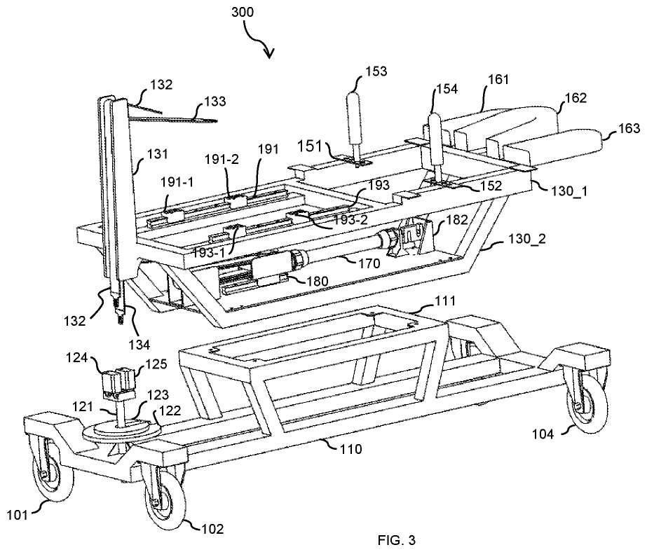

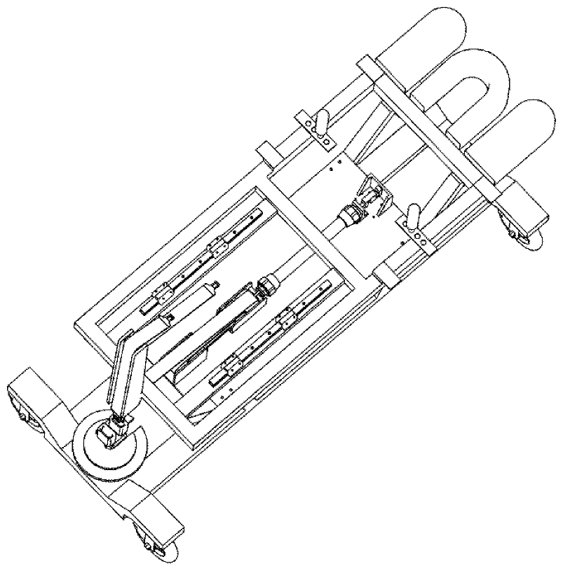

Referring now to FIG. 1 to FIG. 4, top section 130_1 is further divided to a first section and a second section forming a square eight shape. A first sliding track 191 is secured on the left hand side of top section 130_2. A second sliding track 193 is secured on the right hand side of top section 130_2. A first sliding connector 191_1 and a second sliding connector 191_2 are coupled to slide freely on first sliding track 191. Similarly, a third sliding connector 193_1 and a fourth sliding connector 193_2 are coupled to slide freely on second sliding track 193. A first pallet 141 is fixedly secured to first section while second pallet 142 is coupled to first sling connector 191_1, second sliding connector 191_2, third sliding connector 193_1, and third sliding connector 193_2. A first parallel plate 151 is secured perpendicular to the left hand side of top section while a second parallel plate 152 is secured perpendicular on the right hand side. In detail, first parallel plate 151 and second parallel plate 152 each has a plurality of holes arranged along their relative lengths. Moreover, a first pin 153 is used to plug in the plurality of holes of first parallel plate 151 in order to adjust for the body width of each patient. Similarly, a second pin 154 is used to plug in one of the plurality of holes of second parallel plate 152 in order to adjust for the body width of each patient. In another exemplary embodiment of the present invention, a headrest 161 is connected to the middle of the front end of top section 130_1, a first arm rest 162 is connected to the left next to headrest 161, and a second arm rest 163 is connected to the right next to headrest 161.

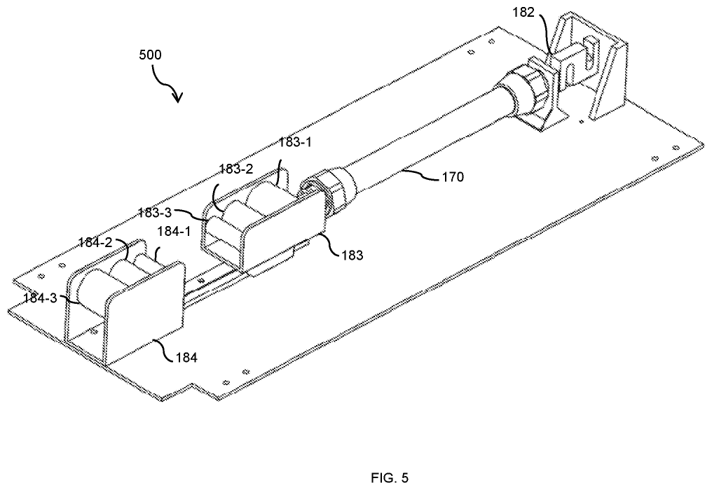

Now referring to FIG. 5, SDM 100 also includes second pulley system 180, a pneumatic artificial muscle (PAM) 170, and a PAM connector 182 secured on a platform of bottom section 130_2. Second pulley system 180, PAM 170, and PAM connector 182 are all connected together in series in a straight line between the front end of bed frame 130 and weight assembly 120. In one embodiment, PAM 170 is MAS-40-N-300-AA-MCFK manufactured by Festo with a diameter of 40 mm and length of 300 mm. This type of PAM has a maximum operating force of 6000 N and permissible contraction of 25%.

Next referring to FIG. 5 which illustrates a top view diagram 500 illustrating the structure of second pulley system 180. In one embodiment as shown in FIG. 5, second pulley system 180 includes a second pulley housing 183 that includes a first pulley 183_1, a second pulley 183_2, and a third pulley 183_3 all connected in series. In the preferred embodiment, in second pulley system 180, third pulley 183_3 has the smallest radius and first pulley 183_1 has the largest radius. Second pulley system 180 also includes a third pulley housing 184 that includes a fourth pulley 184_1, a fifth pulley 184_2, and a sixth pulley 184_3. In second housing 184, fourth pulley 184_1 has the smallest radius and sixth pulley has the largest radius. Second cable 133 and third cable 134 are coupled to second pulley system 180 so that second pulley system 180 serves as a force amplification for PAM 170.

Next referring to FIG. 6 of a 3D top view diagram 600 illustrating the operation of SDM 100 in accordance with an exemplary embodiment of the present invention. At first, user 601 lies on fixed pallet 141 and second pallet 142 with first pin 152 and second pin 153 between the armpits of patient 601. A chest belt 611 is secured around the chest of patient 601 and second pallet 142. A harness 612 is worn around the hip of patient 601 and connected to either first cable 132 or third cable 134, depending on whether a weight mode, a PAM mode, or a combined mode is used. A force sensor 613 is placed at the end of harness 612 to measure the decompression force of either weight mode, PAM mode, or combined mode. A leg support cushion 173 is placed at the popliteal area (back of the knees) of patient 601. In an exemplary embodiment of the present invention, force sensor 163 can be load cells with internal or external threads, S-type force sensors and flat sized force transducers which can be optimally integrated into SDM 100. In another embodiment, force sensor 163 is a low-cost, but yet highly accurate S beam load cell, type K-25, which is available in very small to medium measuring ranges and optionally (available up to 10 kN) provided with a mechanical stop as overload protection against damages, caused by impermissibly high tensile and decompressive forces.

Next, referring to FIG. 7, a side view 700 of spinal decompression machine (SDM) 100 which illustrates the operation of SDM 100 in accordance with an exemplary embodiment of the present invention. Referring also to FIG. 1-FIG. 6, in operation, after the position of patient 601 has been secured by chest belt 611 and harness 612, weight system 120 is used by connecting first cable 132 to harness 612 to find the appropriate decompression force for patient 601—Weights 123 are added until the appropriate decompression force for patient 601 is found. If patient 601 starts to feel pains or weight 123 is not sufficient during weight mode, the combined mode is used to either add more to alleviate the excessive decompression forces for patient 601. The combined mode is used by connecting third cable 134 to second connector 124. The appropriate decompression force is recorded and later on can be used to treat patient 601 by the PAM mode. The PAM mode is selected by disconnecting second cable 134 from second connector 124.

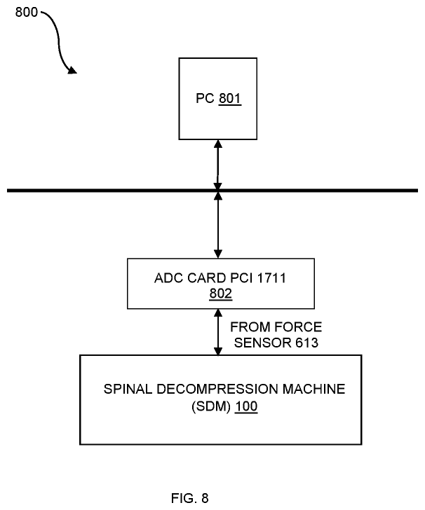

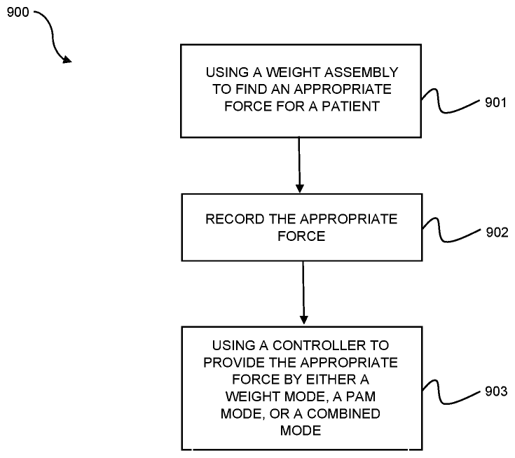

Referring now to FIG. 8 which illustrates system 800 in which SDM 100 is connected to multifunction card 802 controlled by a PC 801. More particularly, force sensor 613 is connected to multifunction card 902. In one exemplary embodiment, multifunction card 802 is an Avantech's PCI 1 100 kS/s, 12-bit, 16-channel universal PCI multifunction DAC card. The operation of knee SDM 100 is described in details in FIG. 9 below. Referring back to FIG. 7, the appropriate decompression force during the weight mode, the PAM mode, or the combined mode is sensed by force sensor 613 and converts to digital signals. The digital decompression force information is stored in a memory of PC 801. Later on, when the same patient 601 is used the SDM 100 again, PC 801 transmits the digital appropriate decompression force signals to multifunction card 802 which converts the digital signals into analog signals that controls PAM 170. In most of the exemplary embodiments, PAM 170 is used to provide additional decompression force, alleviate excessive decompression force from weight assembly 120. Thus, PAM 170 is achieved an objective of the present invention by providing precise decompression forces to the spinal traction of patient 601.

Now referring to FIG. 9, a method 900 for operating knee CPM 100 described above is illustrated. Basically, a weight mode is used first to find the comfortable decompression force for patient 601. After a particular set of decompression force is found for patient 601, the decompression force information is recorded in a memory and then used by a personal computer (PC) 801 to control operation of SDM 100.

The operation of SDM 100 is begun at step 901. That is, an appropriate decompression force is found for a patient. In detail, the patient lies down on SDM 100. Chest belt 611 is fastened between top section 130_1 and the chest of patient 601. Harness 613 is connected to first cable 132. In weight system 120, second cable 134 is disconnected from second connector 125; and first cable 132 is connected to first connector 124. Weights 123 are coupled to pin 122 until appropriate decompression force is found. In another exemplary embodiment, a PAM mode or a combined mode can be also used to find the appropriate decompression force.

Next, at step 902, the appropriate decompression force is stored for subsequent treatments for the same patient. Step 902 is realized by PC 801 and force sensor 613. After appropriate decompression force has been found, force sensor 613 senses the appropriate decompression force and stores it in personal computer (PC) 801. In many exemplary embodiments, PC 801 may be in form of a remote controller, a laptop, a cell phone, a personal digital assistance (PDA) or any devices that have a microprocessor and a memory.

Finally at step 903, the appropriate decompression force is retrieved for subsequent treatments. Once the appropriate decompression force is recorded, three different modes can be used: the weight mode, the PAM mode, and the combined mode. Step 903 can be achieved by spinal decompression machine (SDM) 100 described from FIG. 1 to FIG. 8 above.

The foregoing description details certain embodiments of the invention. It will be appreciated by a person of ordinary skills in the art that connections between various components described herewith may be by any suitable means such as nails, screws, bolts, connectors, pins, staples, dowels and the Ike, It also will be appreciated, however, that no matter how detailed the foregoing appears in text, the invention can be practiced in many ways. As is also stated above, it should be noted that the use of particular terminology when describing certain features or aspects of the invention should not be taken to imply that the terminology is being re-defined herein to be restricted to including any specific characteristics of the features or aspects of the invention with which that terminology is associated. The scope of the invention should therefore be construed in accordance with the appended claims and any equivalents thereof.

### DESCRIPTION OF NUMERALS

100 spinal decompression machine (SDM)

101 first caster wheel

102 second caster wheel

103 third caster wheel

104 fourth caster wheel

111 extension

120 weight assembly

121 weight platform

122 pin

123 weight discs

130 bed frame

130_1 top section

130_2 bottom section

130_3 first pulley system

131 first pulley housing

132 first cable

133 second cable

134 third cable

141 first pallet

142 second pallet

151 first parallel plate

152 second parallel plate

153 first pin

154 second pin

161 headrest

162 first arm rest

163 second arm rest

170 pneumatic artificial muscle (PAM)

173 leg support cushion

180 second pulley system

182 PAM connector

183 second pulley housing

183_1 first pulley

183_2 second pulley

183_3 third pulley

184 third pulley housing

184_1 fourth pulley

184_2 fifth pulley

184_3 sixth pulley

191 first sliding track

191_1 first sliding connector

191_2 second sliding connector

193 second sliding track

193_1 third sliding connector

193_2 fourth sliding connector

601 patient

611 chest belt

612 harness

801 personal computer (PC)

802 Analog to digital converter (ADC)

What is claimed is:

1. A spinal decompression machine (SDM), comprising:
a base having a first caster wheel, a second caster wheel, a third wheel, and a fourth wheel, wherein said first caster wheel, said second caster wheel, said third and said fourth caster wheels are arranged from front to back at four corners of a bottom side of said base respectively;
a bed frame connected on top of said base, wherein said bed frame further comprises a top section and a bottom section, said top section further comprises a fixed pallet and a movable pallet gliding upon a first track and a second track positioned on both sides of said top section;
a weight assembly located on said base;
a pneumatic artificial muscle (PAM) motor located on said bottom section; and
a first pulley system selectively connected to either or both of said weight assembly and said PAM for providing a weight mode in which a first decompression force is provided only by said weight assembly, a pneumatic artificial muscle (PAM) in which second decompression force in provided only by said PAM, or a combined mode in which a combined decompression force is provided by said PAM and said weight assembly.

2. The spinal decompression machine of claim 1 wherein said base further comprises an extension extended vertically from the middle of said base, said extension is mechanically connected to said bottom section of said bed frame.

3. The spinal decompression machine of claim 2 wherein said weight assembly further comprises:
a circular platform
a weight adder pin extended vertically from the center of said circular platform and positioned at the middle of the bottom end of said base;
a plurality of weights;
a first connector; and
a second connector, both said first connector and said second connector are positioned on top of said weight adder pin.

4. The spinal decompression machine of claim 3 further comprises a second pulley system directly connected to said PAM and both said PAM and said second pulley system are located inside said bottom section.

5. The spinal decompression machine of claim 4 wherein said first pulley system further comprises:
a first pulley,
a second pulley,
a third pulley;
a first pulley housing connected to the middle of a bottom side of said top section, wherein said first pulley, said second pulley, and said third pulley are arranged from top to bottom along said first pulley housing;
a first cable wrapped around said second pulley and said third pulley and to said second pulley system so as to connected said PAM to said patient in order to activate said PAM mode;
a second cable wrapped around said first pulley and connected to either said first connector or said second connector to activate said weight mode; and
a third cable connected to either said first connector or said second connector to activate said combined mode.

6. The spinal decompression machine of claim 5 wherein said top section further comprises:
a top frame; and
said fixed pallet; and
said movable pallet.

7. The spinal decompression machine of claim 6 wherein said top frame is further divided into a first section and a second section so that said top frame has a square figure eight shape, wherein said wherein said fixed pallet is fixed to said first section and said movable pallet is connected to said second section.

8. The spinal decompression machine of claim 7 wherein said second section further includes said first sliding track and said second sliding track.

9. The spinal decompression machine of claim 8 wherein said first sliding track and said second sliding track each further comprises a pair of inverted U-shaped sliding connectors capable of sliding on said first sliding track and said second sliding track respectively.

10. The spinal decompression machine of claim 9 wherein said first section further comprises a first body stopper and a second body stopper located on the left side and the right side of said first section, said first body stopper and said second body stopper coupled to armpit of said patient, are operable to prevent said patient from sliding down toward the bottom side of said top section when said decompression forces are activated.

11. The spinal decompression machine of claim 10 wherein said first body stopper and said second body stopper each comprises:
a horizontal plate having a plurality of holes;
a pin inserted to each of said plurality of holes so as to adjust according to the variety of widths of each patient, wherein said pin is coupled to the armpits of said patient.

12. The spinal decompression machine of claim 11 wherein said first section further comprises an adjustable headrest connected to the middle section of the front side of said first section, operable to raise or lower in order to provide comfort to said patient.

13. The spinal decompression machine of claim 12 wherein said first section further comprises:
a first arm rest connected to the left of said head rest;
a second arm rest connected to the right of said head rest on the front side of said first section.

14. The spinal decompression machine of claim 12 further comprising a controller, a memory, and a force sensor.

15. The spinal decompression machine of claim 12 wherein said second pulley system further comprises a first pulley, a second pulley, and a third pulley arranged in series in a straight line with a decrease in radius.

16. The spinal decompression machine of claim 15 wherein said second pulley system further comprises a fourth pulley, a fifth pulley, and a sixth pulley arranged in series in a straight line with an increase in radius, wherein said first cable and said second cable are coupled to said first pulley, said second pulley, said third pulley, said fourth pulley, said fifth pulley, and said sixth pulley.

17. A method of rehabilitating a spine using a spine decompression machine (SDM) having a base, a bed frame, a movable pallet, a weight assembly, a pneumatic artificial muscle (PAM) motor, a system of pulleys, a force sensor, and a controller, said method comprising:
determining an appropriate decompression force for each patient;
recording said decompression force for each patient; and
using said controller to control said pneumatic artificial muscle (PAM) and/or said weight assembly to provide a weight mode in which a first decompression force is provided only by said weight assembly, a pneumatic artificial muscle (PAM) in which second decompression force in provided only by said PAM, or a combined mode in which a combined decompression force is provided by said PAM and said weight assembly.

18. The method of claim 17 wherein said determining an appropriate decompression force for each patient further comprises using said PAM to alleviate any excessive decompression force generated from said weight assembly.

19. The method of claim 17 further comprises:
connecting said patient to a chest belt and said bed frame; and
connecting said patient to a harness; and
connecting said weight assembly to said harness and said decompression force sensor.

20. The method of claim 17 wherein recording said decompression force for each patient further comprises using a memory device electrically coupled to said force sensor and said controller.
